(19) United States
(12) Patent Application Publication
(10) Pub. No.: US 2007/0263275 A1
(43) Pub. Date: Nov. 15, 2007

(54) Spatial Light Modulators with Light Transmissive Substrates

(75) Inventor: Andrew Huibers, Sunnyvale, CA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/745,219

(22) Filed: May 7, 2007

Related U.S. Application Data
(60) Provisional application No. 60/799,257, filed on May 9, 2006.

(51) Int. Cl. G02B 26/00

(52) U.S. Cl. 359/291

(57) ABSTRACT

Disclosed herein is a spatial light modulator having an array of pixels enclosed within a space between a light transmissive substrate and another substrate. The light transmissive substrate is spaced apart from the reflective mirror plates at a distance such that physical defects of the light transmissive substrate are out of focus of the projection system.

This application claims priority under 35 USC § 119(e)(1) of provisional Application No. 60/799,257, filed May 9, 2006.

### TECHNICAL FIELD OF THE INVENTION

The present invention is generally related to the art of spatial light modulators, and more particularly, to spatial light modulators having light transmissive substrates.

### SUMMARY OF THE INVENTION

An object of the present invention is a spatial light modulator comprising a light transmissive substrate and an array of pixels, such as an array of reflective deflectable micromirror devices, plasma cells, liquid crystal cells, liquid crystal on silicon cells, and CCD cells. The light transmissive substrate can be a device substrate on which functional elements of the pixels are formed, or can be a package lid for packaging the pixel array.

The light transmissive substrate, however, may have physical defects on the surfaces or inside the substrate, such as scratches, dents, and miniature particles attached thereto. These physical defects may be carried with the light transmissive substrate, or produced during the fabrication (e.g. packaging), handling, and installation of the micromirror device package. These defects may be imaged on the screen through the modulated light beams, and perceived by the viewer. An approach to solve this problem is to diminish or fade the images of the physical defects by placing the physical defects out of the focus of the projection system, resulting in smeared and hazy images of the physical defects such that the viewer does not detect or perceive the physical defects. For this purpose, it is desired that the pixels of the spatial light modulator be placed as far away as possible. However, the distance between the pixels of light transmissive substrate is under other limitations, which requires the mirror plates and light transmissive substrates be disposed within a certain distance.

According to the invention, the micromirror devices, as well as the mirror plates each may have a characteristic dimension of 100 microns or less, such as 50 microns or less, and 30 microns or less. The vertical distance between the reflective surface of the micromirror devices and the lower surface of the package lid is from 500 microns to 200 microns, more preferably from 700 microns to 1500 microns, and more preferably from 900 to 1100 microns.

In another example, the optical distance between the reflective surface of the micromirror devices and the lower surface of the package lid can be from 500 microns to 200 microns, more preferably from 700 microns to 1500 microns, and more preferably from 900 to 1100 microns. The “optical distance” is defined as the physical distance multiplied by the refractive index of the medium through which the illumination light propagates. The thickness of the light transmissive substrate can be 5 millimeters or less.

Objects and advantages of the present invention will be obvious, and in part appear hereafter and are accomplished by the present invention. Such objects of the invention are achieved in the features of the independent claims attached hereto. Preferred embodiments are characterized in the dependent claims.

### BRIEF DESCRIPTION OF THE DRAWINGS

The accompanying drawings are illustrative and are not to scale. In addition, some elements are omitted from the drawings to more clearly illustrate the embodiments. While the appended claims set forth the features of the present invention with particularity, the invention, together with its objects and advantages, may be best understood from the following detailed description taken in conjunction with the accompanying drawings, in which:

FIG. 1 illustrates a cross-sectional view of an exemplary spatial light modulator having an array of reflective mirror plates, in which embodiments of the invention can be implemented;

FIG. 2 is a perspective view of a spatial light modulator, wherein the light transmissive substrate has physical defects;

FIG. 3 demonstratively illustrates the images of the physical defects in FIG. 4 on a screen of a projection system;

FIG. 4 illustrates a cross-sectional view of an exemplary spatial light modulator in FIG. 1, wherein the light transmissive substrate is a package lid;

FIG. 5 illustrates a cross-sectional view of an exemplary spatial light modulator in FIG. 1, wherein the light transmissive substrate is a device substrate on which the micromirrors are formed; and

FIG. 6 demonstratively illustrates an exemplary projection system.

FIG. 7 illustrates an exemplary illumination system.

FIG. 8 illustrates an exemplary rear projection system.

### DETAILED DESCRIPTION OF THE INVENTION

The present invention discloses a spatial light modulator comprising a light transmissive substrate and an array of pixels, such as an array of reflective deflectable micromirror devices, plasma cells, liquid crystal cells, liquid crystal on silicon cells, and CCD cells. The light transmissive substrate can be a device substrate on which functional elements of the pixels are formed, or can be a package lid for packaging the pixel array. To eliminate perceivable images of the physical defects on the screen, the spatial light modulator is formed such that the optical distance between the pixels and lower surface of the light transmissive substrate is from 1 to 1450 microns, preferably from 15 to 850 microns. The thickness of the light transmissive substrate is preferably 5 millimeters or less. In the following, the present invention will be discussed in detail with reference to examples wherein the pixels of the spatial light modulator are micromirror devices each comprising a reflective and deflectable mirror plate. It will be appreciated by those skilled in the art that the following discussion is for demonstration purposes, and should not be interpreted as a limitation. Instead, other variations without departing from the spirit of the invention are also applicable.

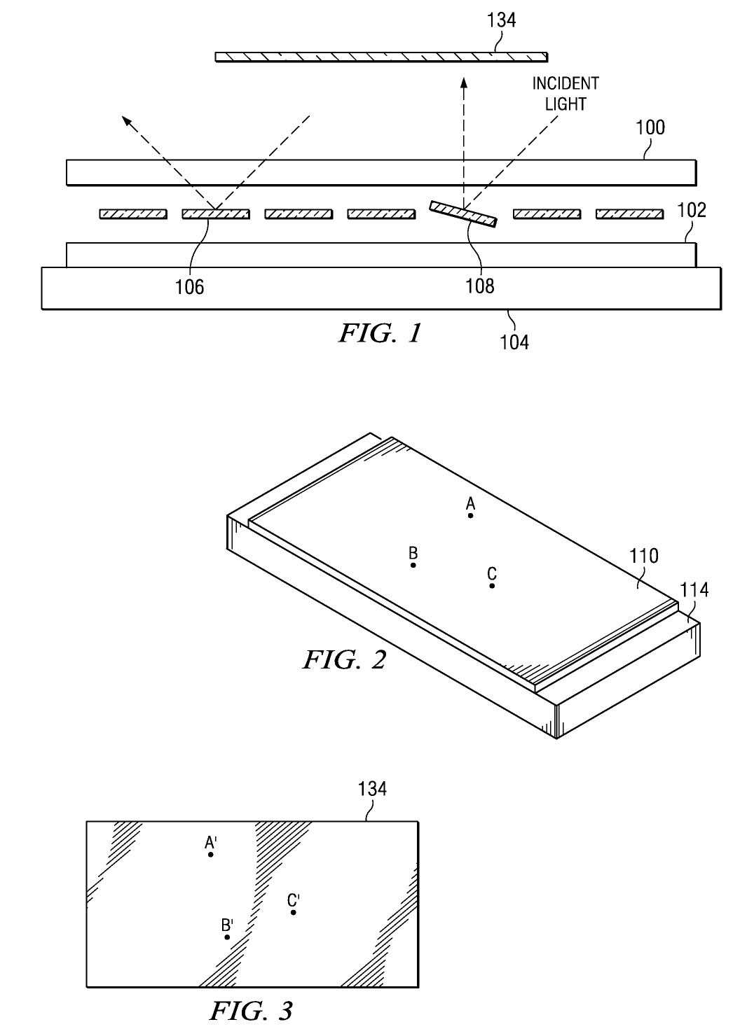

Turning to the drawings, FIG. 1 illustrates a cross-sectional view of a spatial light modulator usable in a projection system, such as rear-projection systems and front-projection systems. The spatial light modulator comprises an array of reflective mirror plates, such as mirror plates 106 and 108, enclosed within a space between light transmissive substrate 100 and semiconductor substrate 102. For simplicity purposes, only seven mirror plates are illustrated in the figure. In general, the micromirror array of the spatial light modulator may comprise any suitable number of reflective deflectable mirror plates, such as 512×384 or higher, 960×540 or higher, 1024×768 or higher, and 1920×1080 or higher. The aspect ratio (the ratio of the number of rows to number of columns in the array) can be standard 4:3 or 16:9 or any desired numbers.

The mirror plates are deflectable with electrostatic forces, such as an electrostatic force derived from an electrostatic field established between the mirror plate and addressing electrode associated with the mirror plate. The addressing electrode can be formed on semiconductor substrate 102, which is not shown for simplicity.

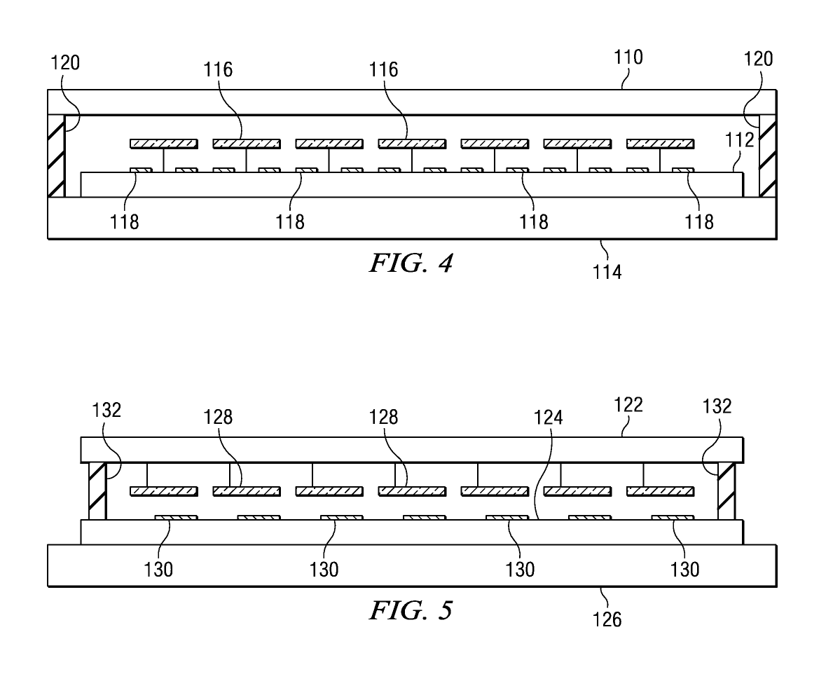

The light transmissive substrate can be glass, quartz, and sapphire, and other suitable substrates that are transparent to the incident light (e.g. visible light) to be modulated. And the light transmissive substrate can be provided for protection of the enclosed micromirrors, or provided as a substrate on which the reflective mirrors are fabricated, which will be discussed in detail with reference to FIG. 4 and FIG. 5.

In operation, the light beam to be modulated is incident to the reflective surfaces of the mirror plates through light transmissive substrate 100, and reflected by the mirror plates into different directions. The reflected (modulated) light beams again pass through light transmissive substrate 100, and travel along different directions. In the example shown in the figure, the reflected light beam from the mirror plate at the ON state (e.g. mirror plate 108) arrives at screen 134 and generates a “bright” image pixel. The reflected light beam from the OFF state (e.g. mirror plate 106) travels away from the screen and results in a “dark” image pixel in the screen.

The light transmissive substrate, however, may have physical defects, such as scratches, dents, and miniature particles attached thereto, as schematically shown in FIG. 2. Referring to FIG. 2, physical defects A, B, and C are present in light transmissive substrate 110 (with the micromirrors, not shown in the figure, enclosed within the space between substrates 110 and 114). These physical defects may be carried with the light transmissive substrate, or produced during the fabrication (e.g. packaging), handling, and installation of the spatial light modulator.

In projecting the desired image, incident light passes through light transmissive substrate 110 and is modulated by the enclosed micromirrors based on the image data derived from the desired image. The modulated light re-passes through the light transmissive substrate from the enclosed micromirrors and propagates towards or away from the screen so as to produce the desired image on the screen. The modulated illumination light, however, also images the physical defects A, B, and C on the screen, as schematically shown in FIG. 3.

Referring to FIG. 3, spots A′, B′, and C′ are images of the physical defects A, B, and C on light transmissive substrate 110 in FIG. 2. These defect images may be perceivable by the viewer, resulting in annoying visual effect. An approach to solve this problem is to diminish or fade the images (e.g. A′, B′, and C′) of the physical defects by placing the physical defects out of the focus at which the reflective surfaces of mirror plates are located, resulting in smeared and hazy images of the physical defects such that the viewer does not detect or perceive the images of the physical defects. For this purpose only, it is desired that the reflective surfaces of the mirror plates and the locations of the physical defects in the light transmissive substrate are disposed as far away as possible. However, such distance suffers from other limitations, which requires the distance between the mirror plates and light transmissive substrate be within a certain range. For example, the lubricant materials and getters are often disposed on the light transmissive substrate, which prefers a shorter distance between the mirror plate and light transmissive substrate. Moreover, an increased distance between the mirror plate and light transmissive substrate also increases the volume of the spatial light modulator, which in turn, increases the production cost. Furthermore, increasing the distance between the mirror plate and light transmissive substrate may require increasing the area of the package. Specifically, the illumination light beam in operation is incident on the surface of the light transmissive substrate and reflective surface of the mirror plates at certain angles, such as 45° degrees. For this reason, the mirror plate array is desired to be shifted on the surface of the package substrate such that the edge of the incident light beam is substantially at the edge of the mirror plate array, and the interception area of the illumination light beam by the mirror plate array is substantially the same as the area of the mirror plate array. Obviously, the displacement of the mirror plate array on the package substrate is proportional to the distance between the light transmissive substrate and reflective surfaces of the mirror plate. Increases in the displacement of the mirror plate array require increase of the package substrate area for accommodating the mirror plate array.

To balance the dilemma, the spatial light modulator can be fabricated such that the vertical distance between the reflective surface of the micromirror devices and the lower surface of the package lid is from 500 microns to 200 microns, more preferably from 700 microns to 1500 microns, and more preferably from 900 to 1100 microns. Alternatively, the optical distance between the reflective surface of the micromirror devices and the lower surface of the package lid can be from 500 microns to 200 microns, more preferably from 700 microns to 1500 microns, and more preferably from 900 to 1100 microns. The “optical distance” is defined as the physical distance multiplied by the refractive index of the medium through which the illumination light propagates. The thickness of the light transmissive substrate can be 5 millimeters or less. The thickness of the light transmissive substrate is preferably 5 millimeters or less, such as 3 millimeters or less, 1 millimeter or less, and 800 microns or less.

The spatial light modulator of FIG. 1 can be of variety of configurations. For example, the light transmissive substrate can be a package lid bonded to a package substrate resulting in a space in which the mirror plates are enclosed, as demonstratively illustrated in FIG. 4.

Referring to FIG. 4, reflective mirror plates (e.g. mirror plate 116) and addressing electrodes (e.g. addressing electrode 118) of the micromirror array are formed on semiconductor substrate 112. The semiconductor substrate is attached to and held by package substrate 114. Package lid 110, which is a light transmissive substrate, is bonded (e.g. hermetically or non-hermetically) to package substrate 114 with spacer 120 such that the micromirror array is enclosed within the space between the package lid and package substrate. The vertical distance (and/or the optical distance) between the reflective surface of the micromirror devices and the lower surface of the package lid is from 500 microns to 200 microns, more preferably from 700 microns to 1500 microns, and more preferably from 900 to 1100 microns. The “optical distance” is defined as the physical distance multiplied by the refractive index of the medium through which the illumination light propagates. The thickness of the light transmissive substrate can be 5 millimeters or less. The thickness of the light transmissive package lid can be 5 millimeters or less, preferably 3 millimeters or less, and 800 microns or less.

The micromirrors of the spatial light modulator in FIG. 1 can be formed on the light transmissive substrate which is referred to as mirror substrate, as shown in FIG. 5. Referring to FIG. 5, reflective mirror plates, such as reflective mirror plate 128, are formed on mirror substrate 122; while addressing electrodes, such as addressing electrode 130, are formed on semiconductor substrate 124 and disposed proximate to the mirror plates for electrostatically moving the mirror plates. Mirror substrate 122 and semiconductor substrate 124 are bonded together with spacer 132 so as to enclose the mirror plates therebetween. The semiconductor substrate is attached to and held by package substrate 126. In the embodiment of the invention, the optical distance between the reflective mirror plates and lower surface of the mirror substrate can be from 1 to 5 microns, such as from 2 to 4 microns. The optical distance between the reflective surfaces of the mirror plates and upper surface of the mirror substrate is from 2 to 600 microns, such as from 300 to 600 microns.

In the above example, another light transmissive substrate—package lid can be provided for protecting the micromirror device. Specifically, the package lid can be disposed above light transmissive substrate 122 and bonded to package substrate 126 so as to enclose the micromirror device within the space between the package lid and package substrate. Because the package lid may also have physical defects, the distance between the reflective mirror plates and lower surface of the package lid is preferably from 1 to 1450 microns, such as from 300 to 1450 microns. The two light transmissive substrates, mirror substrate and package lid, are preferably spaced apart vertically with the optical distance being from 15 to 850 microns. The distance between the upper surfaces of the package lid and mirror substrate can be from 1000 to 5000 microns.

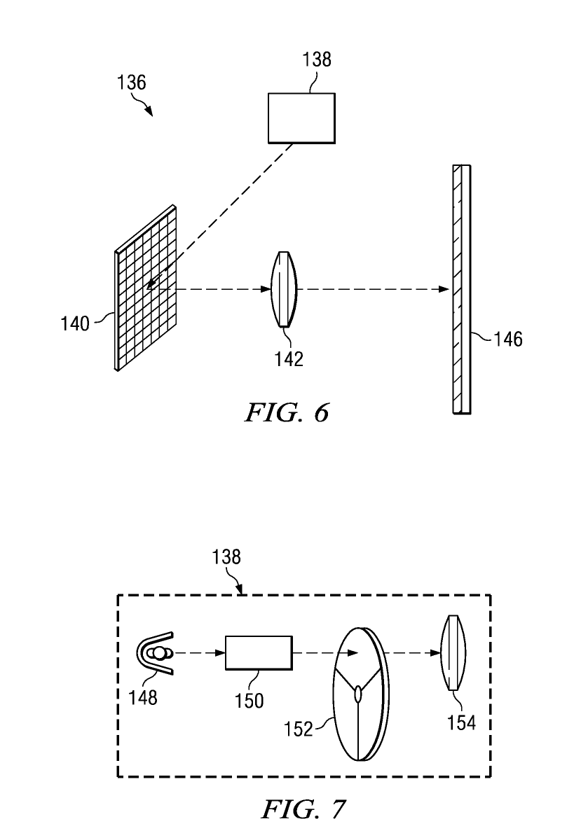

The spatial light modulator of the invention can be implemented in many types of projection systems, such as front projection systems, one of which is demonstratively illustrated in FIG. 6. Referring to FIG. 6, display system 136 comprises illumination system 138 providing light beams to illuminate light valve 140. Light valve 140 comprises an array of micromirror devices, as those shown in FIG. 1 to FIG. 5. The light valve modulates the incident light beam according to image data (such as bitplane data) that are derived from the desired images and video signals. The modulated light beams are collected by projection lens group 142 and projected on screen 146. To successfully project the modulated light and produce the desired images and videos on the screen, the spatial light modulator, especially the reflective surfaces of the mirror plates, are preferably disposed at the focus of the projection lens group 142.

An exemplary illumination system 138 is illustrated in FIG. 7. Referring to FIG. 7, the illumination system comprises light source 148, light pipe 150, color wheel 152, and condensing lens 154. The light source can be an arc lamp with an elliptical reflector. The arc lamp may also be the arc lamps with retro-reflectors, such as Philips BAMI arc lamps. Alternatively, the arc lamp can be arc lamps using Wavien reflector systems each having a double parabola. The light source can also be a LED.

The color wheel comprises a set of color segments, such as red, green, and yellow, or cyan, yellow and magenta. A white or clear or other color segments can also be provided for the color wheel. In the operation, the color wheel spins such that the color segments sequentially pass through the illumination light from the light source and generate sequential colors to be illuminated on the light valve. For example, the color wheel can be rotated at a speed of at least 4 times the frame rate of the image data sent to the spatial light modulator. The color wheel can also be rotated at a speed of 240 Hz or more, such as 300 Hz or more.

The lightpipe is provided for delivering the light from the light source to the color wheel. As an alternative feature, an array of fly's eye lenses can be provided to alter the cross section of the light from the light source.

Condensing lens 154 may have a different f-number than the f-number of projection lens 142 in FIG. 6. In this particular example, the color wheel is positioned after the light pipe along the propagation path of the light beams. In another embodiment, the color wheel can be positioned between the lightpipe and light source, which is not shown in the figure.

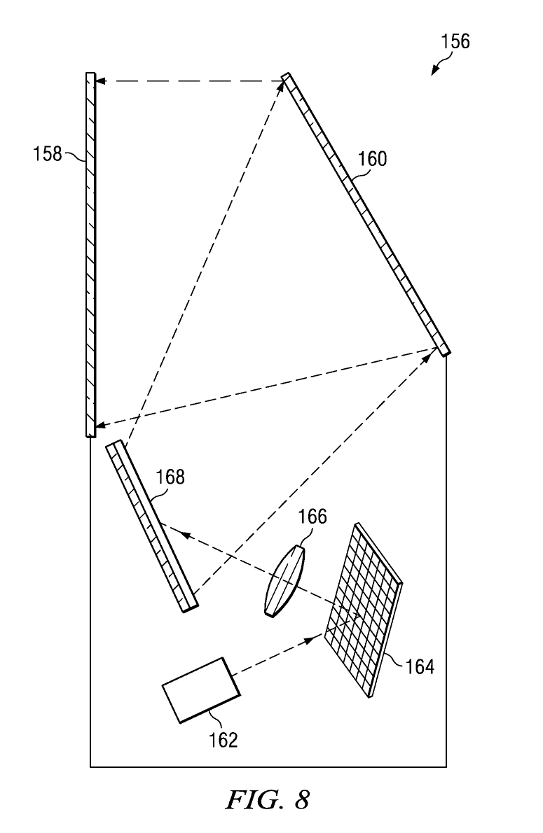

The spatial light modulator of the present invention is also applicable in rear-projection systems, one of which is demonstratively illustrated in FIG. 8. Referring to FIG. 8, projection system 156 comprises illumination system 162 providing illumination light, such as white light with high illumination intensity, for the projection system, light valve 164, as those discussed with reference to FIG. 1 for modulating the illumination light, projection lens 166, folding mirrors 168 and 160, and screen 158.

The illumination system can be the same as that shown in FIG. 7, but not required to be so. The light valve comprises an array of reflective mirror plates for modulating the illumination light based on the image data, such as the bitplane data derived from the desired images and videos. Projection lens 166 collects and projects the modulated light from the micromirrors at the ON state to folding mirror 168, which reflects the projected light from projection lens 166 to folding lens 160. Folding lens 160 projects the folded light from folding lens 168 to screen 158 and illuminates the entire visual area on screen 158.

It will be appreciated by those skilled in the art that a new and useful micromirror array device having a light transmissive substrate has been described herein. In view of the many possible embodiments to which the principles of this invention may be applied, however, it should be recognized that the embodiments described herein with respect to the drawing figures are meant to be illustrative only and should not be taken as limiting the scope of invention. For example, those of skill in the art will recognize that the illustrated embodiments can be modified in arrangement and detail without departing from the spirit of the invention.

We claim:

1. A packaged device, comprising:
a package lid, a portion of which is transparent to visible light;
a package substrate bonded to the package lid forming a space therebetween; and
a spatial light modulator disposed within the space between the package lid and package substrate, wherein the spatial light modulator comprises an array of reflective surfaces of an array of individually addressable micromirror devices; and
wherein a vertical distance between a lower surface of the package lid and the reflective surfaces is from 500 microns to 2000 microns.

2. The device of claim 1, wherein the vertical distance is from 700 microns to 1500 microns.

3. The device of claim 1, wherein the vertical distance is from 900 microns to 1100 microns.

4. The device of claim 1, wherein the reflective surfaces are an array of reflective mirror plates each having a characteristic dimension of 50 microns or less.

5. The device of claim 1, wherein the reflective surfaces are an array of reflective mirror plates each having a characteristic dimension of 30 microns or less.

6. The device of claim 5, wherein the mirror plates are formed on a light transmissive device substrate that is disposed between the reflective surfaces and the package lid.

7. The device of claim 6, wherein an upper surface of the device substrate and a lower surface of the package lid are vertically spaced apart from 150 microns to 400 microns.

8. The device of claim 6, wherein the reflective surfaces are spaced apart vertically from a lower surface of the device substrate from 2 to 10 microns.

9. The device of claim 8, wherein the reflective surfaces are spaced apart from the lower surface from 3 to 5 microns.

10. The device of claim 5, wherein the mirror plates are formed on a semiconductor substrate having formed thereon an array of addressing electrodes each of which is associated with one of the reflective mirror plates.

11. The device of claim 6, wherein each mirror plate is attached to a deformable hinge such that the mirror plate is capable of moving relative to the transparent device substrate; and wherein the mirror plate and deformable hinge are located on separate planes parallel to the transparent device substrate.

12. The device of claim 11, wherein the mirror plate is disposed between the transparent device substrate and the deformable hinge.

13. A projection system, comprising:
an illumination system providing illumination light;
a package comprising:
a package lid, a portion of which is transparent to visible light;
a package substrate bonded to the package lid forming a space therebetween; and
a spatial light modulator disposed within the space between the package lid and package substrate, wherein the spatial light modulator comprises an array of reflective surfaces of an array of individually addressable micromirror devices; and
wherein a vertical distance between a lower surface of the package lid and the reflective surfaces is from 500 microns to 2000 microns; and
an optical lens group for projecting the modulated light to a screen.

14. The device of claim 13, wherein the vertical distance is from 700 microns to 1500 microns.

15. The device of claim 13, wherein the vertical distance is from 900 microns to 1100 microns.

16. The device of claim 13, wherein the reflective surfaces are an array of reflective mirror plates each having a characteristic dimension of 50 microns or less.

17. The device of claim 13, wherein the reflective surfaces are an array of reflective mirror plates each having a characteristic dimension of 30 microns or less.

18. The device of claim 17, wherein the mirror plates are formed on a light transmissive device substrate that is disposed between the reflective surfaces and the package lid.

19. The device of claim 18, wherein an upper surface of the device substrate and a lower surface of the package lid are vertically spaced apart from 150 microns to 400 microns.

20. The device of claim 18, wherein the reflective surfaces are spaced apart vertically from a lower surface of the device substrate from 2 to 10 microns.

21. The device of claim 20, wherein the reflective surfaces are spaced apart from the lower surface from 3 to 5 microns.

22. The device of claim 17, wherein the mirror plates are formed on a semiconductor substrate having formed thereon an array of addressing electrodes each of which is associated with one of the reflective mirror plates.

23. A packaged device, comprising:
a package lid, a portion of which is transparent to visible light;
a package substrate bonded to the package lid forming a space therebetween; and
a spatial light modulator disposed within the space between the package lid and package substrate, wherein the spatial light modulator comprises an array of reflective surfaces of an array of individually addressable micromirror devices; and
wherein an optical distance between a lower surface of the package lid and the reflective surfaces along the normal direction of the package lid is from 500 microns to 2000 microns.

24. The device of claim 23, wherein the vertical distance is from 700 microns to 1500 microns.

25. The device of claim 23, wherein the vertical distance is from 900 microns to 1100 microns.

26. The device of claim 23, wherein the reflective surfaces are an array of reflective mirror plates each having a characteristic dimension of 50 microns or less.

27. The device of claim 23, wherein the reflective surfaces are an array of reflective mirror plates each having a characteristic dimension of 30 microns or less.

28. The device of claim 27, wherein the mirror plates are formed on a light transmissive device substrate that is disposed between the reflective surfaces and the package lid.

29. The device of claim 28, wherein an upper surface of the device substrate and a lower surface of the package lid are vertically spaced apart from 150 microns to 400 microns.

30. The device of claim 28, wherein the reflective surfaces are spaced apart vertically from a lower surface of the device substrate from 2 to 10 microns.

31. The device of claim 27, wherein the mirror plates are formed on a semiconductor substrate having formed thereon an array of addressing electrodes each of which is associated with one of the reflective mirror plates.

32. The device of claim 28, wherein each mirror plate is attached to a deformable hinge such that the mirror plate is capable of moving relative to the transparent device substrate; and wherein the mirror plate and deformable hinge are located on separate planes parallel to the transparent device substrate.

33. The device of claim 32, wherein the mirror plate is disposed between the transparent device substrate and the deformable hinge.
